(19) United States
(12) Patent Application Publication
(10) Pub. No.: US 2023/0359674 A1
(43) Pub. Date: Nov. 9, 2023

(54) WELL AUDIT SYSTEM AND METHOD

(71) Applicant: CUDD PRESSURE CONTROL, INC., THE WOODLANDS, TX (US)

(72) Inventors: John R. HATTEBERG, Spring, TX (US); Laigang SONG, Spring, TX (US); Bhavesh S. RANKA, Sugarland, TX (US)

(21) Appl. No.: 17/735,314

(22) Filed: May 3, 2022

(51) Int. Cl. G06F 16/904

(52) U.S. Cl. CPC G06F 16/904

(57) ABSTRACT

A method can include performing a well audit, inputting well audit data to a database, and displaying a map view of a geographic area, well locations being indicated in the map view, and the well audit data being displayed in response to selection of one of the well locations. Another method can include displaying a graphic representation of components of a wellhead installation, and displaying well data pertaining to one of the components in response to selection of the component. A well information system can include an online database having stored therein well audit data from audits of well locations and customer well data for the well locations, and a display that shows a map view of a geographic area, the well locations being indicated in the map view, and the well audit data and the customer well data being displayed in response to selection of a well location.

### BACKGROUND

This disclosure relates generally to equipment utilized and operations performed in conjunction with a subterranean well and, in an example described below, more particularly provides a well audit system and method.

A well audit can include inspections of components of a wellhead installation at a well location, as well as information (such as, maintenance history, status, photographs, etc.) useful for evaluating a condition or value of the wellhead installation. The components of a wellhead installation can include valves, actuators, chokes, pressure gauges, flowmeters, a tubing hanger, etc.

It will be appreciated that improvements are continually needed in the art of performing well audits and conveying well audit data to customers. The present specification provides such improvements, which can be used with a variety of different types of wellhead installations at multiple different well locations.

### BRIEF DESCRIPTION OF THE DRAWINGS

FIG. 1 is a representative elevational view of an example of a wellhead installation and an associated audit method which can embody principles of this disclosure.

FIG. 2 is a representative view of an example display that may be provided using a well information method that can embody the principles of this disclosure.

FIG. 3 is a representative view of another example display.

FIG. 4 is a representative view of another example display.

FIG. 5 is a representative example of a well information system which may be used with the method.

### DETAILED DESCRIPTION

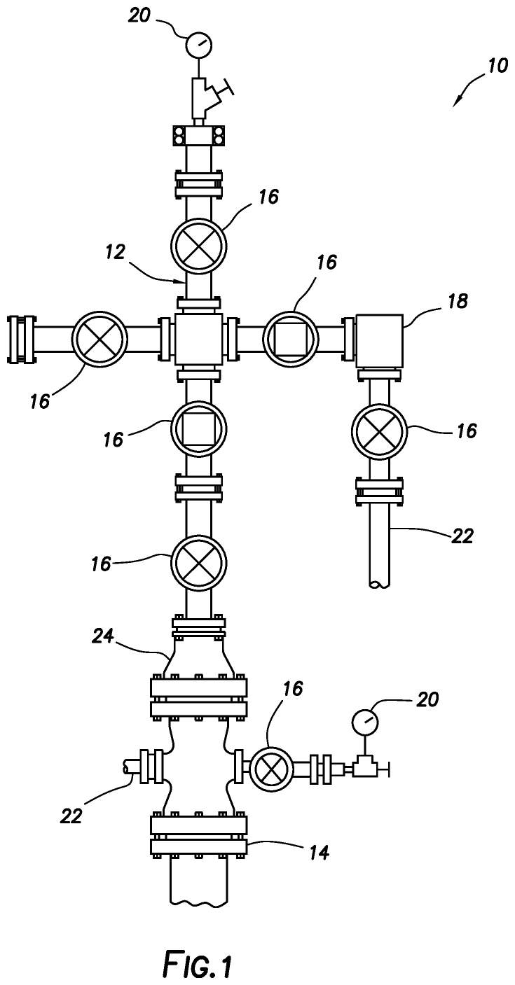

Representatively illustrated in FIG. 1 is a wellhead installation 10 and associated method which can embody principles of this disclosure. However, it should be clearly understood that the wellhead installation 10 and method are merely one example of an application of the principles of this disclosure in practice, and a wide variety of other examples are possible. Therefore, the scope of this disclosure is not limited at all to the details of the wellhead installation 10 and method described herein and/or depicted in the drawings.

In the FIG. 1 example, the wellhead installation 10 includes a “Christmas tree” 12 connected above a wellhead 14. The wellhead installation 10 may be configured for producing or injecting any fluids (such as, oil, gas, gas condensates, water, combinations thereof, etc.) from or into a well associated with the wellhead 14.

The Christmas tree 12 depicted in FIG. 1 includes various valves 16, a choke 18, pressure gauges 20, flow lines 22 and an adapter spool 24 for conducting and controlling flow of fluids into or out of the wellhead 14. More, fewer or different components may be included in a wellhead installation, in keeping with the principles of this disclosure. For example, although the valves 16 appear in FIG. 1 to be manually operated, any of the valves may be operated using a hydraulic, pneumatic or motorized actuator.

To maintain safe, efficient and effective operation of the wellhead installation 10, or to aid in a valuation of the wellhead installation (for example, for financing purposes), it can be useful to perform a well audit. The well audit can include inspection and testing of the components of the wellhead installation 10, as well as accumulation of pertinent data for the wellhead installation (such as, maintenance history, deferred maintenance, well type, wellhead and Christmas tree type, etc.).

It would also be useful to be able to provide this and other information to a customer in a manner that enables the customer to conveniently access the data and to quickly understand the results of the well audit. In addition to the well audit data, it would be helpful if the customer could access other relevant data pertaining to the wellhead installation 10, such as publicly available information or customer supplied information, so that all of the information is readily accessible at the same source.

In one example, the customer can access the wellhead installation information, including well audit data, customer supplied data and publicly available data, using a software application capable of receiving the information from an online database. The software application may be installed on a desktop computer, a notebook computer, a mobile device (such as a tablet or a cellular phone) or any other suitable computing device. The database may be stored on a server at the provider of the well audit service, or at a third party facility (e.g., “in the cloud”) or at any one or more locations.

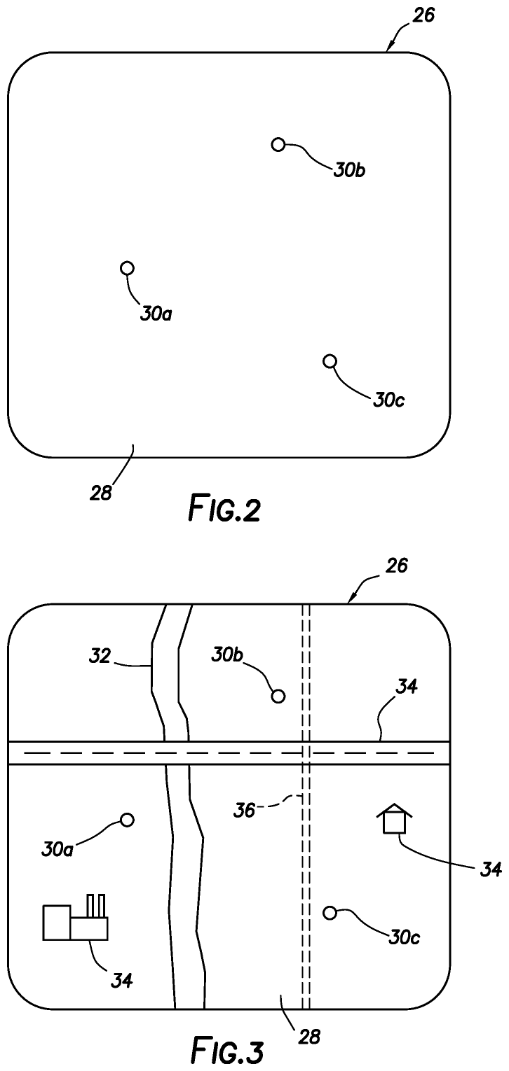

Referring additionally now to FIG. 2, a display 26 produced by the software application running on the computing device and connected to the online database is representatively illustrated. The display 26 depicts a map view of a geographical area 28, such as a county, a particular oil or gas field, a subdivision of the customer's holdings, etc.

In the FIG. 2 example, multiple well locations 30a-c are indicated in the display 26. Each of the displayed well locations 30a-c comprises a physical wellhead installation, such as the wellhead installation 10 depicted in FIG. 1.

If a well audit has been performed for a particular well location 30a-c, then the display 26 can indicate a result of the well audit for that well location. For example, an icon for the well location (a circle in the FIG. 2 example) can have a color corresponding to the result of the well audit. In this example, the icon could be colored green if the well audit found that the wellhead installation is in good condition, the icon could be colored yellow if the well audit found that the wellhead installation needs routine maintenance or remedial work, and the icon could be colored red if the wellhead installation is in need of immediate attention or repair.

Necessary or recommended remedial work for the displayed geographical area 28 can be shown in the display 26. For example, a list of remedial work can be displayed, and the list can be arranged in order of priority, with the most urgently needed remedial work appearing first in the list and routine remedial work (such as regularly scheduled maintenance) listed after the more urgently needed remedial work. In this manner, a customer can devote its resources most effectively and efficiently to the most urgently needed remedial work identified in the list.

If a user selects a particular one of the well locations 30a-c, the data stored in the database for that well location can be displayed in any of a variety of different formats (such as, in table form, as a graphic representation, in narrative form, etc.). As mentioned above, the data can include well audit data (e.g., specifying the functionality and condition of particular components of the wellhead installation), customer supplied data (e.g., the customer's identification of the well location, production data, etc.) and/or publicly available data (e.g., well data maintained by the American Petroleum Institute or a particular state). A prioritized list of remedial work for the selected well location 30a-c can also be displayed.

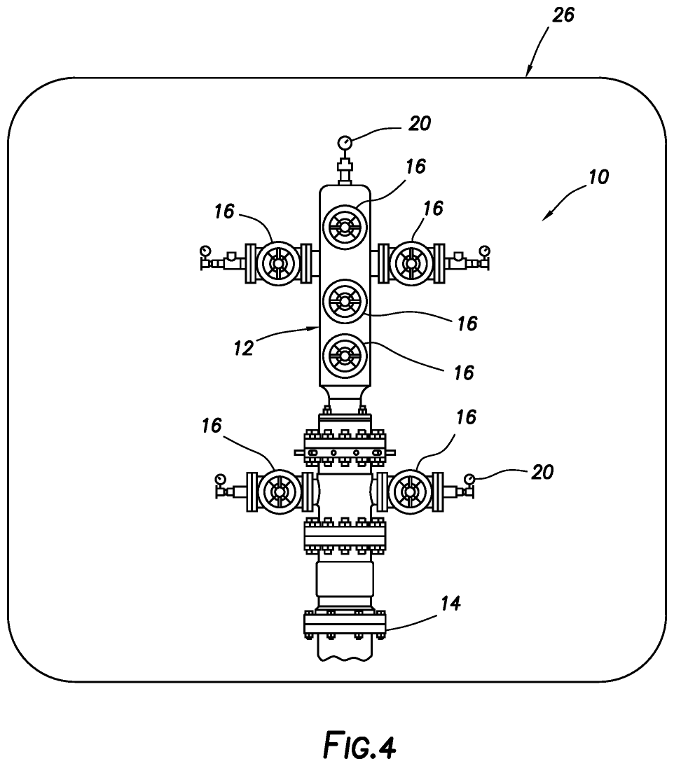

Referring additionally now to FIG. 3, another example of the display 26 is representatively illustrated. In the map view shown in the FIG. 3 display, certain surface and subsurface features of the geographical area 28 are depicted along with the well locations 30a-c.

The surface features can include natural features 32 (such as a river or lake) and surface structures 34 (such as a road or building). The subsurface features can include subsurface structures 36 (such as a pipeline, water line or sewer line). More, fewer or different features may be displayed in other examples.

The display 26 including the surface and subsurface features 32, 34, 36 in addition to the well locations 30a-c can aid in identifying the well locations 30a-c and in planning remedial work for each of the well locations.

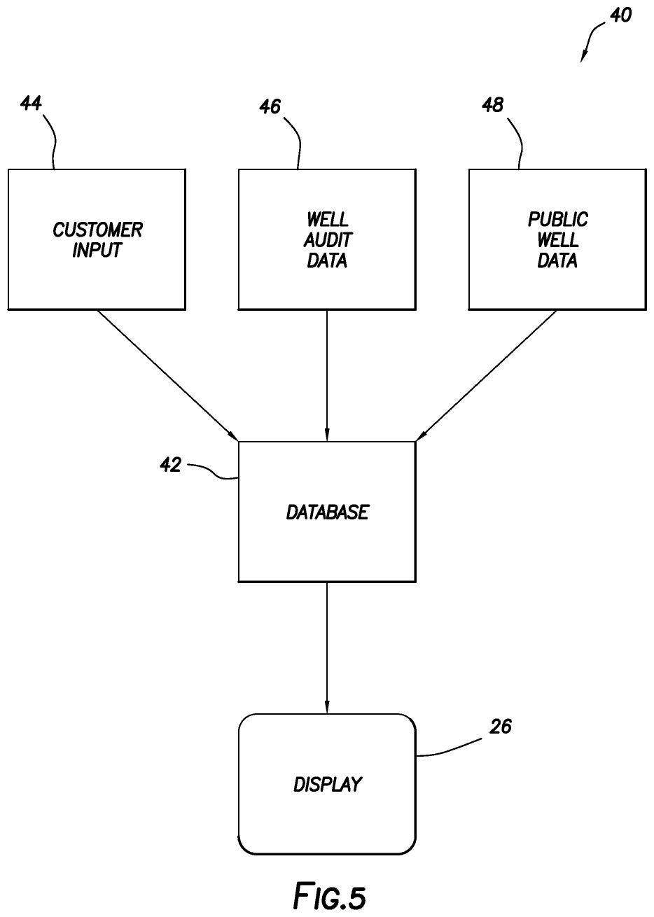

Referring additionally now to FIG. 4, another example display 26 is representatively illustrated. In this example, a graphic representation of a particular wellhead installation 10 is shown in response to selecting a respective one of the well locations 30a-c shown in the FIGS. 2 & 3 displays 26.

For example, after a well audit has been performed, and the well audit data has been input to the online database, a customer (or another authorized person) can view the FIG. 2 or 3 display 26 and select a particular one of the well locations 30a-c. Upon selecting one of the well locations 30a-c (such as, by “clicking” on the well location using a movable cursor and a mouse or joystick, or using keyboard arrow keys to highlight the well location and then pressing an “enter” or “return” key, etc.), the computer device accesses the well data stored in the database and displays the graphical representation of the wellhead installation 10 at that particular well location.

After the wellhead installation 10 at the selected well location 30a-c is depicted in the display 26, the customer can select one of the components of the wellhead installation. Upon selecting one of the wellhead installation 10 components (such as, one of the valves 16 or the wellhead 14 shown in the display 26), data stored in the database pertaining to that component can be displayed. The data may include results of a test or inspection performed during the well audit, the well component type and manufacturer's part number, a serial number, maintenance history, original installation date, any needed remedial work, etc. The data accessed from the database and displayed in response to selection of the well component can include pertinent well audit data, customer supplied data or publicly available data, or any combination thereof.

Referring additionally now to FIG. 5, a well information system 40 which may be used with the method is representatively illustrated in schematic form. As depicted in FIG. 5, the well information depicted in the display 26 is obtained from the online database 42. In actual practice, the display 26 can be part of, or connected to, a computing device that performs the function of accessing the well information from the database 42. The computing device will process the well information prior to causing it to be depicted in the display 26.

In this example, the well information stored in the database 42 includes data 44 input by the customer, well audit data 46 (which can be input by the well auditor), and publicly available well data 48 (such as, the American Petroleum Institute well data). However, it should be clearly understood that the scope of this disclosure is not limited to storage of any particular type or combination of well data, or from any particular source, in the online database 42.

Upon input of the well audit data 46 to the database 42, the customer can be notified (e.g., via email or text message, etc.) that the well audit data is available. This notification could be automatically generated in response to the input of the well audit data 46 to the database 42, or the notification could be separately initiated.

It may now be fully appreciated that the present disclosure provides significant advances to the art of performing well audits and conveying well audit data and other well information to customers. In examples described above, customer supplied data 44, well audit data 46 and publicly available well data 48 is conveniently available to a customer (or another authorized person) in a graphical display 26. The information is stored in and accessed from the online database 42 and is, thus, available at any location with online access (such as, via the Internet).

The above disclosure provides to the art a method of providing well data 44, 46, 48 to a customer. In one example, the method includes performing at least one well audit, well audit data 46 resulting from the well audit; inputting the well audit data 46 to a database 42; and displaying a map view of a geographic area 28. Multiple well locations 30a-c are indicated in the map view, and the well audit data 46 is displayed in response to selection of a respective one of the well locations 30a-c.

The method may include receiving customer well data 44 to the database 42. The displaying step can include the customer well data 44 being displayed in response to the selection of the respective one of the well locations 30a-c.

The method may include receiving public well data 48 to the database 42. The displaying step can include the public well data 48 being displayed in response to the selection of the respective one of the well locations 30a-c.

The displaying step may include displaying in the map view at least one of a natural feature 32, a surface structure 34, a subsurface structure 36 and a building. The displaying step may include displaying in the map view an indication of a result of the well audit for the selected well location 30a-c. The indication may comprise a displayed color of the selected well location 30a-c.

The displaying step may include displaying a graphic representation of a wellhead installation 10 in response to the selection of the respective well location 30a-c. The displaying step may further include displaying the well audit data 46 in response to selection of a component of the wellhead installation 10.

The method may include notifying the customer of availability of the well audit data 46 in response to the inputting of the well audit data 46 to the database 42. The method may include prioritizing remedial work needed at the well locations 30a-c, based on the well audit data 46.

Another example method of providing well data 44, 46, 48 to a customer is provided by the above disclosure. In this example, the method includes displaying a graphic representation of a wellhead installation 10, the graphic representation comprising multiple components of the wellhead installation 10; and displaying the well data 44, 46, 48 pertaining to one of the components in response to selection of the component.

The well data pertaining to the selected component may comprises well audit data 46 that resulted from an audit of the wellhead installation 10, data 44 input by the customer, or data 48 obtained from a public database.

The method may include performing at least one well audit, and the well data may comprise well audit data 46 resulting from the well audit.

The method can include displaying a map view of a geographic area 28, with multiple well locations 30a-c being indicated in the map view. The graphic representation of the wellhead installation 10 may be displayed in response to selection of a respective one of the well locations 30a-c.

The map view displaying step can include displaying in the map view at least one of a natural feature 32, a surface structure 34, a subsurface structure 36 and a building. The map view displaying step can include displaying in the map view an indication of a result of a well audit for the selected well location 30a-c. The indication may comprise a displayed color of the selected well location 30a-c.

The method may include prioritizing remedial work needed at the wellhead installation 10, based on the well audit data 46.

A well information system 40 is also described above. In one example, the system 40 can include an online database 42 having stored therein well audit data 46 from audits of multiple well locations 30a-c and customer well data 44 for the well locations 30a-c; and a display 26 that shows a map view of a geographic area 28. The well locations 30a-c are indicated in the map view, and the well audit data 46 and the customer well data 44 are displayed in response to selection of a respective one of the well locations 30a-c.

The online database 42 may have stored therein public well data 48 for each of the well locations 30a-c. The public well data 48 may be displayed in response to the selection of the respective one of the well locations 30a-c.

The map view may include a representation of at least one of a natural feature 32, a surface structure 34, a subsurface structure 36 and a building. The map view may include an indication of a result of the respective well audit for the selected well location 30a-c. The indication may comprise a displayed color of the selected well location 30a-c.

The display 26 may include a graphic representation of a wellhead installation 10 in response to the selection of the respective well location 30a-c. The display 26 may include the well audit data 46 for a component of the wellhead installation 10.

The well audit data 46 for the component of the wellhead installation 10 may be displayed in response to selection of the component in the display 26. The display 26 may include a prioritized list of remedial work needed at the well locations 30a-c, based on the well audit data 46.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used. The embodiments are described merely as examples of useful applications of the principles of the disclosure, which is not limited to any specific details of these embodiments.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A method of providing well data to a customer, the method comprising:
performing at least one well audit, well audit data resulting from the well audit;
inputting the well audit data to a database; and
displaying a map view of a geographic area, multiple well locations being indicated in the map view, and the well audit data being displayed in response to selection of a respective one of the well locations.

2. The method of claim 1, further comprising receiving customer well data to the database, and in which the displaying further comprises the customer well data being displayed in response to the selection of the respective one of the well locations.

3. The method of claim 1, further comprising receiving public well data to the database, and in which the displaying further comprises the public well data being displayed in response to the selection of the respective one of the well locations.

4. The method of claim 1, in which the displaying further comprises displaying in the map view at least one of the group consisting of a natural feature, a surface structure, a subsurface structure and a building.

5. The method of claim 1, in which the displaying further comprises displaying in the map view an indication of a result of the well audit for the selected well location.

6. The method of claim 5, in which the indication comprises a displayed color of the selected well location.

7. The method of claim 1, in which the displaying further comprises displaying a graphic representation of a wellhead installation in response to the selection of the respective well location.

8. The method of claim 7, in which the displaying further comprises displaying the well audit data in response to selection of a component of the wellhead installation.

9. The method of claim 1, further comprising notifying the customer of availability of the well audit data in response to the inputting of the well audit data to the database.

10. The method of claim 1, further comprising prioritizing remedial work needed at the well locations, based on the well audit data.

11. A method of providing well data to a customer, the method comprising:
displaying a graphic representation of a wellhead installation, the graphic representation comprising multiple components of the wellhead installation; and
displaying the well data pertaining to one of the components in response to selection of the one of the components.

12. The method of claim 11, in which the well data pertaining to the selected one of the components comprises well audit data that resulted from an audit of the wellhead installation.

13. The method of claim 11, in which the well data pertaining to the selected one of the components comprises data input by the customer.

14. The method of claim 11, in which the well data pertaining to the selected one of the components comprises data obtained from a public database.

15. The method of claim 11, further comprising performing at least one well audit, and in which the well data comprises well audit data resulting from the well audit.

16. The method of claim 15, further comprising displaying a map view of a geographic area, multiple well locations being indicated in the map view, and the graphic representation of the wellhead installation being displayed in response to selection of a respective one of the well locations.

17. The method of claim 16, in which the map view displaying further comprises displaying in the map view at least one of the group consisting of a natural feature, a surface structure, a subsurface structure and a building.

18. The method of claim 16, in which the map view displaying further comprises displaying in the map view an indication of a result of a well audit for the selected well location.

19. The method of claim 18, in which the indication comprises a displayed color of the selected well location.

20. The method of claim 15, further comprising prioritizing remedial work needed at the wellhead installation, based on the well audit data.

21. A well information system, comprising:
an online database having stored therein well audit data from audits of multiple well locations and customer well data for the well locations; and
a display that shows a map view of a geographic area, the well locations being indicated in the map view, and the well audit data and the customer well data being displayed in response to selection of a respective one of the well locations.

22. The well information system of claim 21, in which the online database has stored therein public well data for each of the well locations.

23. The well information system of claim 22, in which the public well data is displayed in response to the selection of the respective one of the well locations.

24. The well information system of claim 21, in which the map view comprises a representation of at least one of the group consisting of a natural feature, a surface structure, a subsurface structure and a building.

25. The well information system of claim 21, in which the map view comprises an indication of a result of the respective well audit for the selected well location.

26. The well information system of claim 25, in which the indication comprises a displayed color of the selected well location.

27. The well information system of claim 21, in which the display comprises a graphic representation of a wellhead installation in response to the selection of the respective well location.

28. The well information system of claim 27, in which the display further comprises the well audit data for a component of the wellhead installation.

29. The well information system of claim 28, in which the well audit data for the component of the wellhead installation is displayed in response to selection of the component in the display.

30. The well information system of claim 21, in which the display further comprises a prioritized list of remedial work needed at the well locations, based on the well audit data.
